(19) United States
(12) Patent Application Publication
(10) Pub. No.: US 2017/0114214 A1
(43) Pub. Date: Apr. 27, 2017

(54) HIPS MATERIAL, COMPOSITE PANEL AND REFRIGERATION DEVICE HAVING THE COMPOSITE PANEL

(71) Applicants: HEFEI HUALING CO., LTD., Hefei (CN); HEFEI MIDEA REFRIGERATOR CO., LTD., Hefei (CN)

(72) Inventors: Xiangzuo Shi, Hefei (CN); Yuanyuan Ren, Hefei (CN); Yaonan Huo, Hefei (CN); Li Jia, Hefei (CN); Ling Huang, Hefei (CN)

(73) Assignees: HEFEI HUALING CO., LTD., Hefei (CN); HEFEI MIDEA REFRIGERATOR CO., LTD., Hefei (CN)

(21) Appl. No.: 15/301,810

(22) PCT Filed: Sep. 17, 2014
(86) PCT No.: PCT/CN2014/086728

§ 371 Date: Oct. 4, 2016

(30) Foreign Application Priority Data
Apr. 18, 2014 (CN) 201410158836.4

(51) Int. Cl. C08L 25/06; F25D 23/06; B32B 27/32; B32B 5/16; B32B 27/08; B32B 27/30

(52) U.S. Cl. CPC C08L 25/06; B32B 27/08; B32B 27/302; B32B 27/32; B32B 5/16; F25D 23/066; B32B 2260/025; B32B 2264/0207; B32B 2264/0235; B32B 2307/406; B32B 2509/10; B32B 2307/558; B32B 2307/714; C08L 2205/025; C08L 2205/035; C08L 2205/06; C08L 2207/322; C08L 2201/08; F25D 2400/18

(57) ABSTRACT

Disclosed are a HIPS material, a composite panel and a refrigeration device having the composite panel. The HIPS material comprises: 45 to 55 parts by weight of HIPS; 15 to 25 parts by weight of rubber; 10 to 15 parts by weight of polyethylene; 1 to 10 parts by weight of naphthenic oil; and 1 to 10 parts by weight of an additive. The HIPS material according to an embodiment of the present disclosure has higher glossiness and excellent corrosion resistance.

### FIELD

The present disclosure relates to a material processing field, in particularly to a high impact polystyrene (HIPS) material, a composite panel and a refrigeration device having the composite panel.

### BACKGROUND

In the related art, a high light panel used in a refrigerator/freezer is generally a HIPS composite panel, and mainly used in high-end or exported refrigerator/freezer liner. Typically, a panel layer is high light HIPS, i.e., common high light polystyrene, such as HIPS-1180 (Styron), which has an advantage of higher glossiness, and defeats of low strength, fragility, and low corrosion resistant. A liner, in particularly a liner of the body, obtained thereof easily cracks, thus bringing a quality issue. Because the common high light polystyrene is fragile, and is of a low glossiness, and meanwhile an elongation is big after thermoforming, the high light layer of the liner is nonuniform, and the actual glossiness is low, thus increasing the risk of cracking during use of the liner.

Therefore, the current composite panel needs to be further studied.

### SUMMARY

Embodiments of the present disclosure seek to solve at least one of the problems existing in the related art to at least some extent. Accordingly, an object of the present disclosure is to provide a HIPS material, a composite panel and a refrigeration device having the composite panel. The HIPS material has higher glossiness and good corrosion resistance.

In a first aspect of the present disclosure, HIPS material is provided. In one embodiment of the present disclosure, the HIPS material includes:

45 to 55 parts by weight of HIPS,

15 to 25 parts by weight of rubber,

10 to 15 parts by weight of polyethylene,

1 to 10 parts by weight of naphthenic oil, and

1 to 10 parts by weight of an additive.

The HIPS material according to embodiments of the present disclosure has higher glossiness and good corrosion resistance.

Additionally, the composite panel according to the above embodiment of the present disclosure further has additional technical features as follows:

In some embodiments of the present disclosure, the HIPS is at least one selected from HIPS-1180, HIPS-888G and HIPS-825G.

In some embodiments of the present disclosure, the rubber has an average molecular weight of 50000 to 300000. Thus, the rigidity of the HIPS material may be significantly decreased.

In some embodiments of the present disclosure, the rubber is at least one selected from styrene-ethylene-butylene-styrene block copolymer (SEBS), styrene-butylene-styrene block copolymer (SBS), butadiene-styrene rubber and cis-polybutadiene. Thus, the rigidity of the HIPS material may be further increased.

In some embodiments of the present disclosure, the rubber has a particle size of 0.5 to 1.5 μm. Thus, the rigidity of the HIPS material may be further decreased.

In some embodiments of the present disclosure, the polyethylene has a density of 0.8 to 1.1 g/cm³. Thus, the corrosion resistance of the HIPS material may be significantly improved.

In some embodiments of the present disclosure, the naphthenic oil has a viscosity of 45 to 55 mm²/S. Thus, the glossiness of the HIPS material may be significantly improved.

In some embodiments of the present disclosure, the naphthenic oil is at least one selected from KG16C, KN4006 and KN4010. Thus, the glossiness of the HIPS material may be further improved.

In some embodiments of the present disclosure, the additive includes at least one of a stabilizer, a dispersant and a compatilizer. Thus, a combination property of the HIPS material may be significantly improved.

In some embodiments of the present disclosure, the stabilizer is at least one of a Ba/Cd compound stabilizer, a Ba/Zn compound stabilizer and a Ca/Zn compound stabilizer.

In some embodiments of the present disclosure, the dispersant is at least one of polyethylene wax and polyethylene glycol.

In some embodiments of the present disclosure, the compatilizer is at least one of RPS, PE-g-ST and PP-g-ST.

In a second aspect of the present disclosure, a composite panel is provided. In one embodiment of the present disclosure, the composite panel includes:

a substrate, and

a panel layer formed on an upper surface of the substrate and formed of the HIPS material described above.

The composite panel according to embodiments of the present disclosure has the higher glossiness and the good corrosion resistance.

Additionally, the composite panel according to the above embodiment of the present disclosure further has additional technical features as follows:

In some embodiments of the present disclosure, the panel layer is formed on the upper surface of the substrate by co-extrusion for a composite panel.

In some embodiments of the present disclosure, the substrate is at least one selected from HIPS 2710 (BASF-YPC), HIPS 2710 (BASF, South Korea), HIPS 8265 (TOTAL) and HIPS 825S (TAIHUA, Ningbo, China).

In some embodiments of the present disclosure, a thickness of the panel layer accounts for 1 to 5%, for example 2%, of that of the composite panel.

In a third aspect of the present disclosure, a refrigeration device is provided. In one embodiment of the present disclosure, the refrigeration device includes the composite panel described above.

In the refrigeration device according to embodiments of the present disclosure, the composite panel described above having the high light and the corrosion resistance is used as a panel layer material of the liner of the refrigeration device, so that the panel layer of the liner has the higher glossiness and the good corrosion resistance. In particularly, a corrosion cracking resistance to cooking oil and detergents may be significantly improved. Aesthetics of the refrigeration device is improved and the repair rates and the rates of complaints caused by the cracking of the liner of the refrigeration device are decreased at the same time, so as to solve the problem about the corrosion cracking of the liner of the refrigeration device.

Additionally, the refrigeration device according to the above embodiment of the present disclosure further has additional technical features as follows:

In some embodiments of the present disclosure, the refrigeration device is a refrigerator or a freezer.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a schematic view of a composite panel according to an embodiment of the present disclosure.

### DETAILED DESCRIPTION

Reference will be made in detail to embodiments of the present disclosure. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

In a first aspect of the present disclosure, HIPS material is provided. In one embodiment of the present disclosure, the HIPS material comprises: 45 to 55 parts by weight of HIPS, 15 to 25 parts by weight of rubber, 10 to 15 parts by weight of polyethylene, 1 to 10 parts by weight of naphthenic oil, and 1 to 10 parts by weight of an additive. The inventors have found that the HIPS material with such composition have the higher glossiness, the excellent elongation and the good corrosion resistance. Specifically, notch impact strength of the HIPS material is ≧10 KJ/M², and tensile strength is ≧25 MPa, elongation at break is ≧55%, and glossiness is ≧85 GU (measured under a condition of 60 GU).

According to some embodiments of the present disclosure, a specific type of the HIPS is not particularly limited in the composition of the HIPS material. In some embodiments of the present disclosure, the HIPS is at least one selected from HIPS-1180, HIPS-888G and HIPS-825G. Specifically, HIPS may be used as a base stock.

According to some embodiments of the present disclosure, a specific type of the rubber is not particularly limited in the composition of the HIPS material. In some embodiments of the present disclosure, the rubber has an average molecular weight of 50000 to 300000. The inventors have found that low molecular weight rubber has excellent ageing resistance, and at the same time has plasticity, high elasticity and good machinability, so that the rigidity of the HIPS material may be significantly decreased. For example, the rubber is at least one selected from SEBS, SBS, butadiene-styrene rubber and cis-polybutadiene. According to embodiments of the present disclosure, the particle size of the rubber is not particularly limited. In some embodiments of the present disclosure, the rubber has the particle size of 0.5 to 1.5 μm. The inventors have found that the rubber with the smaller particle size may be distributed more uniformly in a mixture, so as to decrease the rigidity of the HIPS material significantly as the modified material.

According to some embodiments of the present disclosure, a specific type of the polyethylene is not particularly limited in the composition of the HIPS material. In some embodiments of the present disclosure, the polyethylene has a density of 0.8 to 1.1 g/cm³. The inventors have found that low density polyethylene may reduce toughness and improve stress corrosion cracking resistance of the material, so that the corrosion resistance of the HIPS material may be significantly improved by low density polyethylene.

According to some embodiments of the present disclosure, a specific type of the naphthenic oil is not particularly limited in the composition of the HIPS material. In some embodiments of the present disclosure, the naphthenic oil has a viscosity of 45 to 55 mm²/S. Specifically, the naphthenic oil may be a saturated naphthenic oil. For example, the naphthenic oil is at least one selected from KG16C, KN4006 and KN4010. The inventors have found that if a viscosity of the naphthenic oil is too low, the tensile strength and the elongation at break of HIPS material may be decreased, so that the rigidity of the material is too low, however, if the viscosity is too high, the rigidity of the material may be too high.

According to some embodiments of the present disclosure, a specific type of the additive is not particularly limited in the composition of the HIPS material. In some embodiments of the present disclosure, the additive includes at least one of a stabilizer, a dispersant and a compatilizer. In a specific embodiment of the present disclosure, the stabilizer is at least one of a Ba/Cd compound stabilizer, a Ba/Zn compound stabilizer and a Ca/Zn compound stabilizer; the dispersant is at least one of polyethylene wax and polyethylene glycol; and the compatilizer is at least one of RPS, PE-g-ST and PP-g-ST. Thus, the combination property of the HIPS material may be improved significantly.

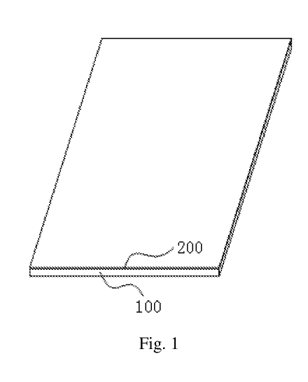

In a second aspect of the present disclosure, a composite panel is provided. With reference to FIG. 1, the composite panel according to embodiments of the present disclosure may be described in detail. In one embodiment of the present disclosure, the composite panel includes: a substrate 100 and a panel layer 200. In a specific embodiment of the present disclosure, the panel layer 200 is formed on an upper surface of the substrate 100 and formed of the HIPS material described above. Thus, the composite panel has the higher glossiness and the excellent corrosion resistance.

According to embodiments of the present disclosure, the combination form of the panel layer 200 and the substrate 100 is not particularly limited. In some embodiments of the present disclosure, the panel layer 200 is formed on the upper surface of the substrate 100 by co-extrusion for a composite panel. According to embodiments of the present disclosure, a specific type of the substrate 100 is not particularly limited. In some embodiments of the present disclosure, the substrate 100 may be HIPS, for example may be at least one selected from HIPS 2710 (BASF-YPC), HIPS 2710 (BASF, South Korea), HIPS 8265 (TOTAL) and HIPS 825S (TAIHUA, Ningbo, China). According to embodiments of the present disclosure, the thickness of the panel layer 200 is not particularly limited. In a specific embodiment, a thickness of the panel layer 200 accounts for 1 to 5%, for example 2%, of that of the composite panel. The inventors have found that if the thickness of the panel layer is too thin, the glossiness is insufficient, however if the thickness of the panel layer is too thick, the cost of material may be increased accordingly.

Specifically, in accordance with the composition, rubber, polyethylene and naphthenic oil are added into a blender mixer and mixed uniformly, and then HIPS is added into the blender mixer to be mixed uniformly under stirring, and finally the additive is added uniformly, thus obtaining a mixed material. A new HIPS material having high light and corrosion resistant may be obtained by granulation using a co-rotating twin screw extruder with a high length/diameter ratio (L/D) (L/D≧36), which is added to the composite panel, as a panel layer material, in a thickness of the panel layer 200 accounting for 2% of that of the composite panel, so as to form the composite panel.

In a third aspect of the present disclosure, a refrigeration device is provided. In one embodiment of the present disclosure, the refrigeration device includes the composite panel described above. According to embodiments of the present disclosure, a specific type of the refrigeration device may not be particularly limited. In a specific embodiment of the present disclosure, the refrigeration device is a refrigerator or a freezer. Specifically, the composite panel may be thermoformed to form a body/door liner of the refrigerator or the freezer. The inventor have found that the composite panel having the high light and corrosion resistant described above is used as a panel layer material of the liner of the refrigeration device, so that the panel layer of the liner has the higher glossiness and the good corrosion resistance. In particularly, the corrosion cracking resistance to cooking oil and detergents may be significantly improved. Aesthetics of the refrigeration device is improved and the repair rates and the rates of complaints caused by the cracking of the liner of the refrigeration device are decreased at the same time, so as to solve the problem about the corrosion cracking of the liner of the refrigeration device.

Specifically, the HIPS material has the higher glossiness and the good distribution, and may be distributed uniformly during co-extrusion. It has the good tensile property and the high corrosion resistance at the same time. Therefore, effect of elongation generated during thermoforming of the body liner on HIPS may be minimized so as to greatly improve the glossiness of the liner and the corrosion resistance of the liner.

With reference to specific embodiments of the present disclosure, the disclosure is described in detail. It should be understood that these embodiments are only illustrated and shall not be construed to limit the present disclosure.

### Example 1

Composition:

450 g of HIPS-1180, 150 g of SEBS (the average molecular weight of 50000 to 150000), 100 g of polyethylene (the density of 0.95 g/cm³), 10 g of KG16C (the viscosity of 48 mm²/S), 15 g of Ca/Zn compound stabilizer, 10 g of polyethylene wax and 12 g of RPS.

Preparation Method:

The rubber, the polyethylene and the naphthenic oil were added into a blender mixer and mixed uniformly, and then the HIPS was added into the blender mixer to be mixed uniformly under stirring, and finally the stabilizer, the dispersant and the compatilizer were added uniformly, thus obtaining a mixed material. A new HIPS material having the high light and corrosion resistance was obtained by granulation using a co-rotating twin screw extruder with a high length/diameter ratio (L/D) (L/D≧36), which was added to the composite panel, as a panel layer, in a thickness of the panel layer accounting for 2% of that of the composite panel, so as to form the composite panel. The composite panel was thermoformed into the body/door liner of the refrigerator or the freezer.

### Example 2

Composition:

550 g of HIPS-888G, 250 g of SEBS (the average molecular weight of 50000 to 150000), 150 g of polyethylene (the density of 0.95 g/cm³), 100 g of KG16C (the viscosity of 48 mm²/S), 10 g of Ba/Zn compound stabilizer, 15 g of polyethylene glycol and 12 g of PE-g-ST.

Preparation method: the same as Example 1.

### Example 3

Composition:

500 g of HIPS-825G, 200 g of SEBS (the average molecular weight of 50000 to 150000), 125 g of polyethylene (the density of 0.95 g/cm³), 50 g of KG16C (the viscosity of 48 mm²/S), 12 g of Ba/Cd compound stabilizer, 12 g of polyethylene wax and 8 g of PP-g-ST.

Preparation method: the same as Example 1.

### Comparative Example 1

Composition:

500 g of HIPS-825G, 200 g of SEBS (the average molecular weight of 50000 to 150000), 125 g of polyethylene (the density of 1.65 g/cm³), 50 g of KG16C (the viscosity of 48 mm²/S), 15 g of Ba/Cd compound stabilizer, 10 g of polyethylene wax and 12 g of PP-g-ST.

Preparation method: the same as Example 1.

### Comparative Example 2

Composition:

500 g of HIPS-825G, 200 g of SEBS (the average molecular weight of 50000 to 150000), 125 g of polyethylene (the density of 0.50 g/cm³), 50 g of KG16C (the viscosity of 48 mm²/S), 15 g of Ba/Cd compound stabilizer, 10 g of polyethylene wax and 12 g of PP-g-ST.

Preparation method: the same as Example 1.

### Comparative Example 3

Composition:

500 g of HIPS-825G, 200 g of SEBS (the average molecular weight of 450000 to 850000), 125 g of polyethylene (the density of 0.95 g/cm³), 5 g of KG16C (the viscosity of 48 mm²/S), 15 g of Ba/Cd compound stabilizer, 10 g of polyethylene wax and 12 g of PP-g-ST.

Preparation method: the same as Example 1.

### Comparative Example 4

Composition:

500 g of HIPS-825G, 200 g of SEBS (the average molecular weight of 10000 to 30000), 125 g of polyethylene (the density of 0.95 g/cm³), 5 g of KG16C (the viscosity of 48 mm²/S), 15 g of Ba/Cd compound stabilizer, 10 g of polyethylene wax and 12 g of PP-g-ST.

Preparation method: the same as Example 1.

### Comparative Example 5

Composition:

500 g of HIPS-825G, 200 g of SEBS (the average molecular weight of 50000 to 150000), 125 g of polyethylene (the density of 0.95 g/cm³), 5 g of KG16C (the viscosity of 60 mm²/S), 15 g of Ba/Cd compound stabilizer, 10 g of polyethylene wax and 12 g of PP-g-ST.

Preparation method: the same as Example 1.

### Comparative Example 6

Composition:

500 g of HIPS-825G, 200 g of SEBS (the average molecular weight of 50000 to 150000), 125 g of polyethylene (the density of 0.95 g/cm³), 5 g of KG16C (the viscosity of 40 mm²/S), 15 g of Ba/Cd compound stabilizer, 10 g of polyethylene wax and 12 g of PP-g-ST.

Preparation method: the same as Example 1.

### Comparative Example 7

Composition:

700 g of HIPS-825G, 400 g of SEBS (the average molecular weight of 50000 to 150000), 200 g of polyethylene (the density of 0.95 g/cm³), 200 g of KG16C (the viscosity of 48 mm²/S), 10 g of Ba/Cd compound stabilizer, 15 g of polyethylene wax and 10 g of PP-g-ST.

Preparation method: the same as Example 1.

### Comparative Example 8

Composition:

300 g of HIPS-825G, 50 g of cis-polybutadiene (the average molecular weight of 50000 to 150000), 200 g of polyethylene (the density of 0.95 g/cm³), 2 g of KG16C (the viscosity of 48 mm²/S), 10 g of Ba/Cd compound stabilizer, 6 g of polyethylene wax and 8 g of PP-g-ST.

Preparation method: the same as Example 1.

### Comparative Example 9

Composition:

300 g of HIPS-1180, 150 g of cis-polybutadiene (the average molecular weight of 400000 to 850000), 10 g of KN4006 (the viscosity of 60 mm²/S), 10 g of Ba/Cd compound stabilizer, 6 g of polyethylene wax and 8 g of PP-g-ST.

Preparation Method:

The HIPS-1180, cis-polybutadiene and the naphthenic oil were added into a blender mixer under stirring and mixed uniformly, and then the stabilizer, the dispersant and the compatilizer were added uniformly, thus obtaining a mixed material. HIPS material was obtained by granulation using a single screw extruder, which was added to the composite panel, as a panel layer, in a thickness of the panel layer accounting for 2% of that of the composite panel, so as to form the composite panel. The composite panel was thermoformed into a body/door liner of the refrigerator or the freezer.

Evaluation:

1. The glossiness and corrosion resistance of each liner obtained from Examples 1 to 3 and Comparative Examples 1 to 9 were measured respectively.

2. Evaluation indexes and measurement methods:

Glossiness: A glossmeter is used. The glossmeter is placed on an object to be measured and starts to measure by pressing the measure button. The surface glossiness of the object is shown on the display screen of the glossmeter, and the glossmeter beeps at the same time to represent a confirmed measurement.

Corrosion resistance: using an environmental stress cracking resistance (ESCR) test, an effect of cooking oil on a strip of the liner of the refrigerator is evaluated. In the ESCR test, the strip is curved on a certain fixture to a certain strain level (in accordance with 25% strain) and then the cooking oil is applied to the highest strain area of the strip. The strip is exposed to the strain and the cooking oil continuously for a certain period (4 h, 8 h, and 24 h respectively).

Results are shown in Table 1.

TABLE 1

| | glossiness/GU | corrosion resistance |
|---|---|---|
| Example 1 | 90 | excellent |
| Example 2 | 93 | excellent |
| Example 3 | 91 | excellent |
| Comparative Example 1 | 72 | medium |
| Comparative Example 2 | 70 | medium |
| Comparative Example 3 | 46 | poor |
| Comparative Example 4 | 80 | good |
| Comparative Example 5 | 73 | medium |
| Comparative Example 6 | 79 | good |
| Comparative Example 7 | 51 | poor |
| Comparative Example 8 | 37 | poor |
| Comparative Example 9 | 40 | poor |

Conclusion: it can be known from the above results that the liners obtained from Examples 1 to 3 of the present disclosure have higher glossiness and better corrosion resistances, and the liner of Example 2 has a best property in which the glossiness is up to 93 GU.

The densities of polyethylene in the composition of Comparative Examples 1-2 are not within the scope of the present disclosure. The molecular weights of rubber in the composition of Comparative Examples 3-4 are not within the scope of the present disclosure. The viscosities of the naphthenic oil in the composition of Comparative Examples 5-6 are not within the scope of the present disclosure. The contents of components in the composition of Comparative Examples 7-8 are not within the scope of the present disclosure. Comparative Example 9 is an existing technology (low density polyethylene is not added). With reference to data in Table 1, the glossiness and the corrosion resistance of liners obtained from Comparative Examples 1-9 are inferior to those of liners obtained from Examples 1 to 3, thus indicating that the density of polyethylene, the average molecular weights of rubber, the viscosities of naphthenic oil and contents of components may all have effect on the glossiness and the corrosion resistance of the liner, and the liner prepared according to the present disclosure has the higher glossiness and the excellent corrosion resistance.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A high impact polystyrene (HIPS) material, comprising:
45 to 55 parts by weight of HIPS,
15 to 25 parts by weight of rubber,
10 to 15 parts by weight of polyethylene,
1 to 10 parts by weight of naphthenic oil, and
1 to 10 parts by weight of an additive.

2. The HIPS material according to claim 1, wherein the HIPS is at least one selected from HIPS-1180, HIPS-888G and HIPS-825G.

3. The HIPS material according to claim 1, wherein the rubber has an average molecular weight of 50000 to 300000.

4. The HIPS material according to claim 3, wherein the rubber is at least one selected from styrene-ethylene-butylene-styrene block copolymer (SEBS), styrene-butylene-styrene block copolymer (SBS), butadiene-styrene rubber and cis-polybutadiene.

5. The HIPS material according to claim 1, wherein the rubber has a particle size of 0.5 to 1.5 μm.

6. The HIPS material according to claim 1, wherein the polyethylene has a density of 0.8 to 1.1 g/cm3.

7. The HIPS material according to claim 1, wherein the naphthenic oil has a viscosity of 45 to 55 mm2/S.

8. The HIPS material according to claim 7, wherein the naphthenic oil is at least one selected from KG16C, KN4006 and KN4010.

9. The HIPS material according to claim 1, wherein the additive comprises at least one of a stabilizer, a dispersant and a compatilizer.

10. The HIPS material according to claim 9, wherein the stabilizer is at least one of a Ba/Cd compound stabilizer, a Ba/Zn compound stabilizer and a Ca/Zn compound stabilizer.

11. The HIPS material according to claim 9, wherein the dispersant is at least one of polyethylene wax and polyethylene glycol.

12. The HIPS material according to claim 9, wherein the compatilizer is at least one of RPS, PE-g-ST and PP-g-ST.

13. A composite panel, comprising:
a substrate, and
a panel layer formed on an upper surface of the substrate and formed of the HIPS material according to claim 1.

14. The composite panel according to claim 13, wherein the panel layer is formed on the upper surface of the substrate by co-extrusion for a composite panel.

15. The composite panel according to claim 13, wherein the substrate is at least one selected from HIPS 2710 (BASF-YPC), HIPS 2710 (BASF, South Korea), HIPS 8265 (TOTAL) and HIPS 825S (TAIHUA, Ningbo, China).

16. The composite panel according to claim 13, wherein a thickness of the panel layer accounts for 1 to 5% of that of the composite panel.

17. The composite panel according to claim 16, wherein the thickness of the panel layer accounts for 2% of that of the composite panel.

18. A refrigeration device, comprising the composite panel according to claim 13.

19. The refrigeration device according to claim 18, wherein the refrigeration device is a refrigerator or a freezer.
